(19) United States
(12) Patent Application Publication
(10) Pub. No.: US 2013/0097250 A1
(43) Pub. Date: Apr. 18, 2013

(54) Protocol and Method for Securely and Remotely Controlling a Plurality of Target Applications on a Server Network

(71) Applicant: Evgeny Zion, Richmond Hill (CA)

(72) Inventor: Evgeny Zion, Richmond Hill (CA)

(21) Appl. No.: 13/275,671

(22) Filed: Oct. 18, 2011

(51) Int. Cl. G06F 15/16

(52) U.S. Cl. 709/206

(57) ABSTRACT

There is disclosed a Protocol and Common Method for remotely and securely controlling a plurality of target applications on a server network. The system includes a mail server configured to send and receive emails to and from a plurality of remote users, the mail server having a unique mailbox for storing emails received from each of the remote users. The system further includes a control application configured to control each target application by means of a plurality of text commands and read emails in the unique mailboxes. The control application is further configured to identify a text command in an email. The control application is configured to read a reference file containing a set of instructions for each target application on how the control application shall treat text commands for that target application, the control application being further configured to execute the text commands pursuant to the sets of instructions.

### FIELD OF THE INVENTION

The invention relates generally to systems and methods for remotely controlling one or more applications resident on a network of servers utilizing SMTP protocol.

### BACKGROUND OF THE INVENTION

The idea of triggering server actions using email is not new and this method of communication is simple, elegant and does not require special connection oriented tools such as ssh or vpn. However, since the non controlled execution of arbitrary commands on the server is not acceptable, this method is never considered as an operational tool in Server production environment. The growing popularity of UNIX/LINUX servers brings up virtually unlimited variety of very complex environments which require constant attention of system and database administrators, application support personal, help desk etc. The event management and system monitoring tools help to react to the operational incidents and to prevent critical production problems. The enterprises invest lot of funds into such tools, in order to minimize operational downtime and increase productivity.

Unfortunately, not everything can be automated. Often, the members of support staff need to log into the server in order to perform some manual work or even simply test server condition. Sometimes, running a single command or script on a server and viewing the results can help to diagnose the problem and to provide the right solution. However, sometimes (and it can happen in most critical situations), the access to remote system is not available due to physical or geographical restrictions. The only equipment which may be available for support person is his smart phone, and the only tool he can use is email messaging. If he were able to run some diagnostics tests on the problematic server, probably he would be able to solve the problem or at least recommend some action, but due to the lack of such tool, the problem can still be unsolved for a time or solved in a wrong way (which is sometimes even worse). There is therefore a need for a tool which allows a remote user to securely send commands to one or more target applications on a server network and have those commands executed by the server network.

### SUMMARY OF THE INVENTION

In accordance with one aspect of the present invention, there is provided a Protocol and Common Method for remotely and securely controlling a plurality of target applications on a server network. The system includes a mail server coupled to the server, the mail server configured to send and receive emails to and from a plurality of remote users, the mail server having a unique mailbox for storing emails received from each of the remote users. The system further includes a control application configured to control each target application by means of a plurality of text commands, the control application configured to read emails in the unique mailboxes. The control application is further configured to identify a text command in an email. The control application is configured to read a reference file, the reference file containing a set of instructions for each target application on how the control application shall treat text commands for that target application, the control application being further configured to execute the text commands pursuant to the sets of instructions.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

DESCRIPTION OF THE DRAWINGS

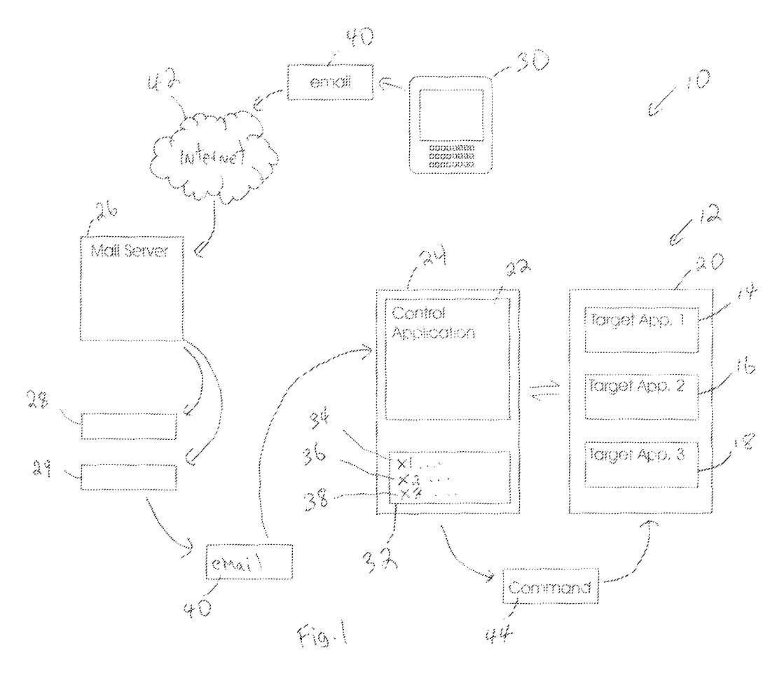

FIG. 1 is a schematic representation of the system of the present invention.

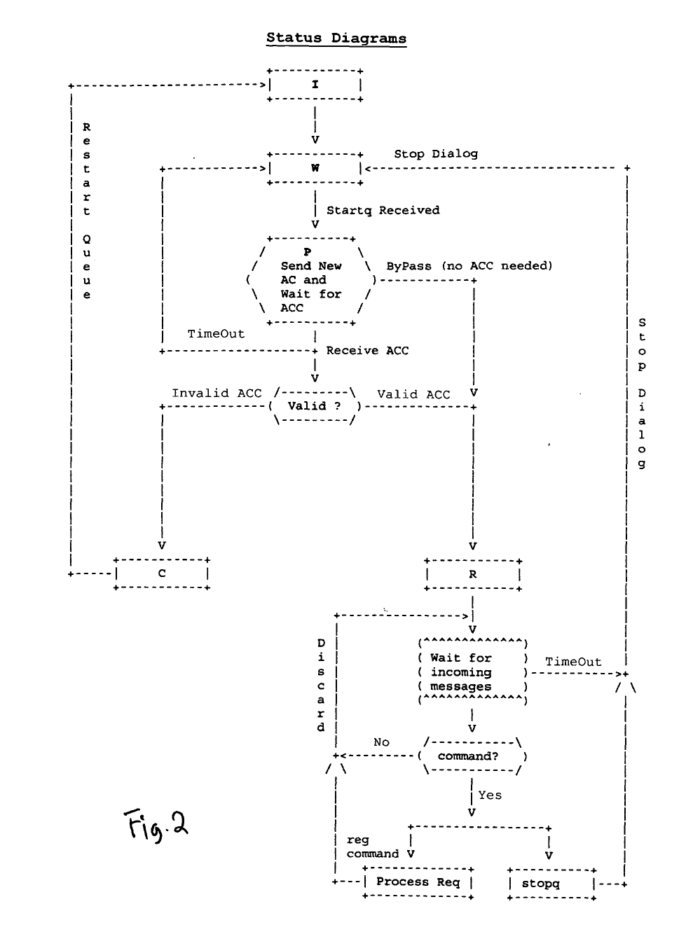

FIG. 2 a flowchart showing how the status of the system of the invention changes depending on the receipt of remote commands from a user.

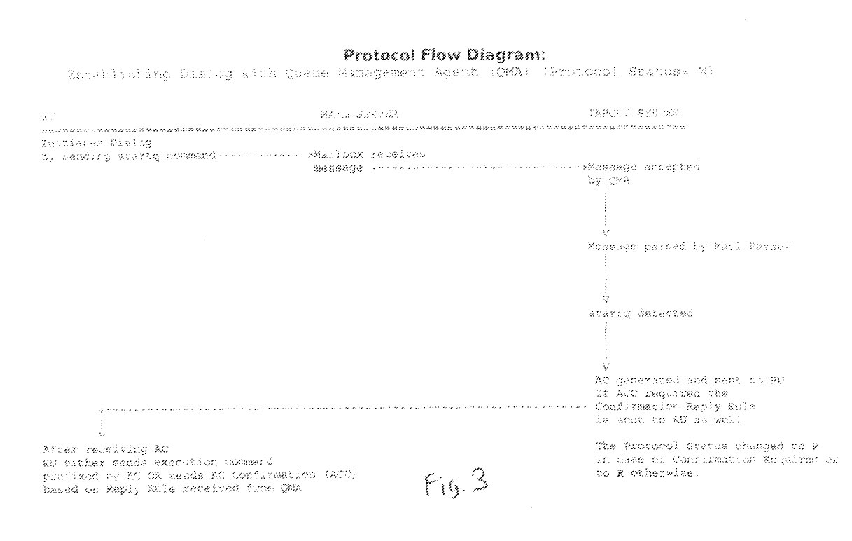

FIG. 3 is a schematic representation of the protocol flow for establishing dialog with the queue management agent portion of the present invention.

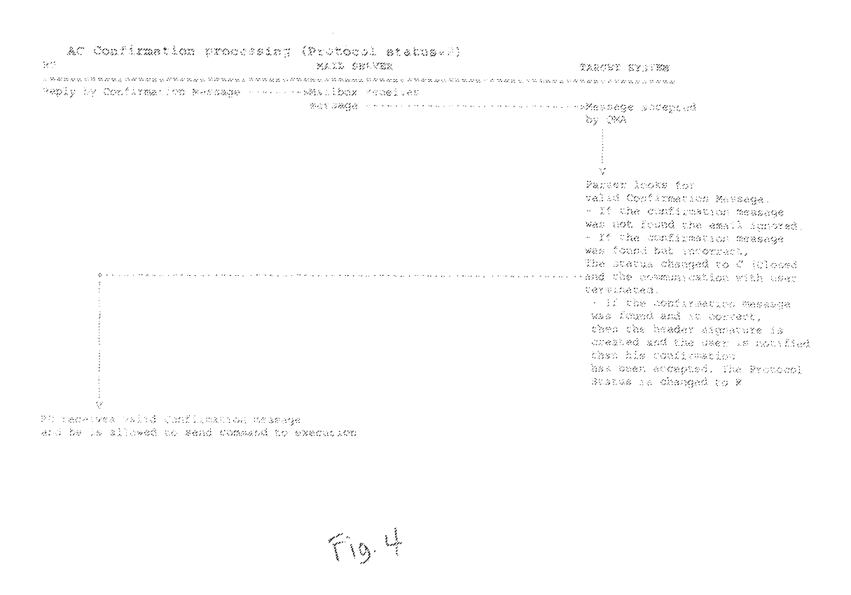

FIG. 4 is a schematic representation of the confirmation process portion of the present invention.

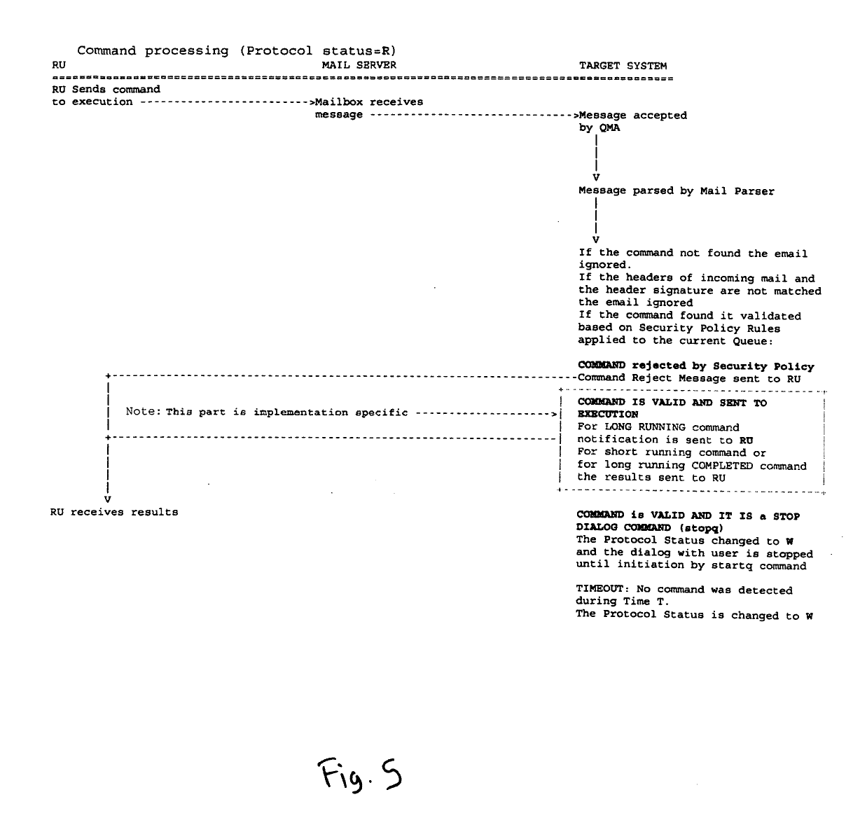

FIG. 5 is a schematic representation of how email commands are processed using the method of the present invention.

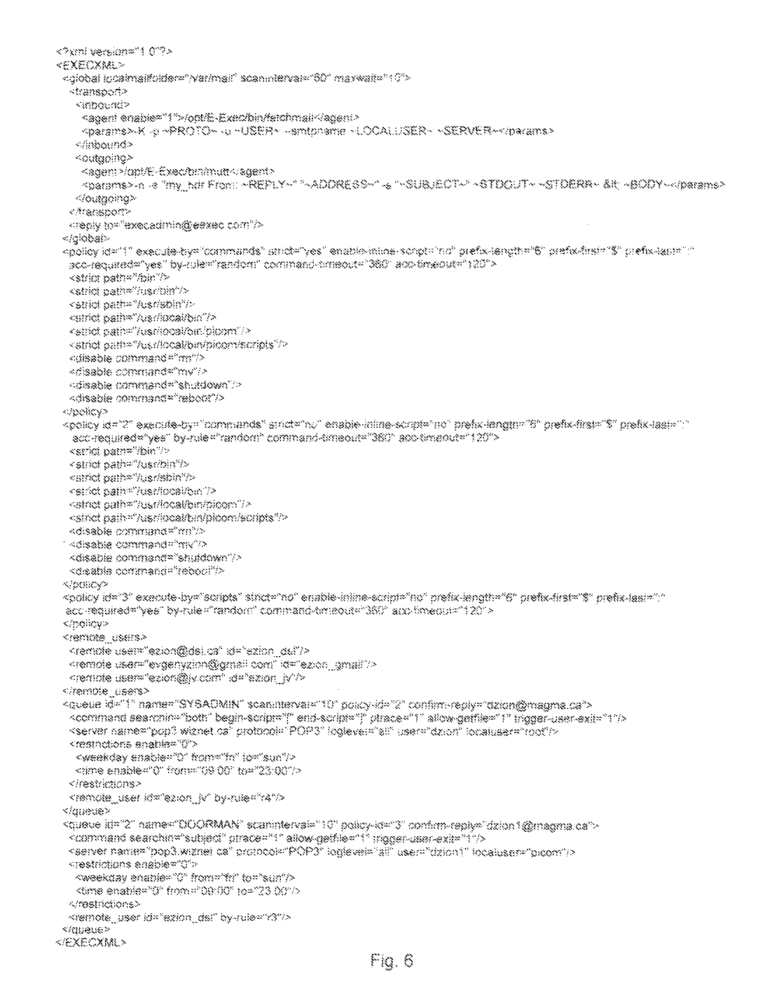

FIG. 6 is a sample XML file controlling the operation of the control application portion of the present invention for use in an email banking implementation.

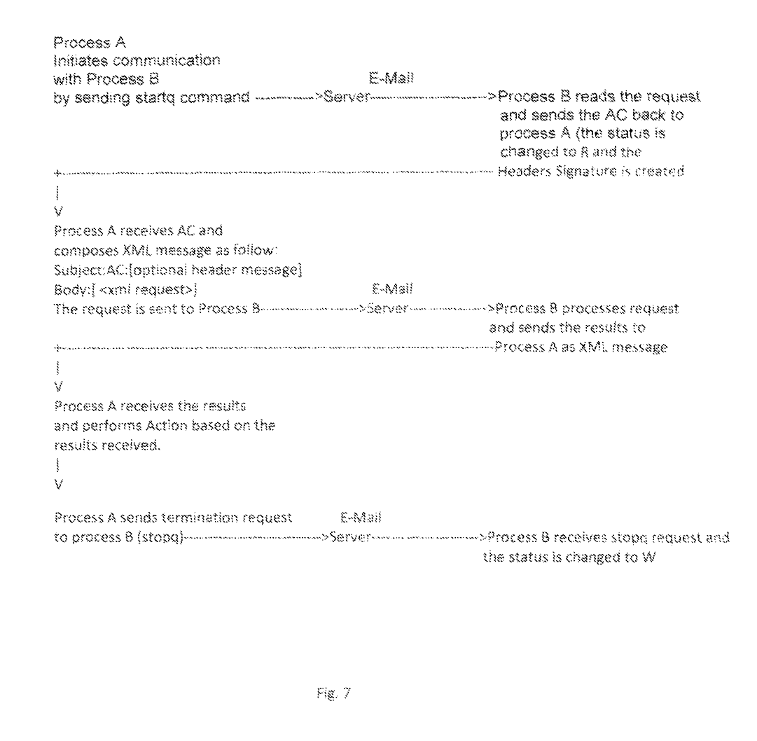

FIG. 7 is a schematic representation of invention being used to control operations between two Processes A and B.

In the drawings like characters of reference indicate corresponding parts in the different figures.

### DETAILED DESCRIPTION OF THE INVENTION

Referring to FIG. 1, the system of the present invention, shown generally as item 10, consists of a server network 12 running one or more target applications 14, 16 and 18 located on one or more servers 20. Control application 22 is resident on server 24 which part of server network 12. Mail server 26 is part of the system and is configured to place email messages within mailboxes 28 and 29. Control application 22 configured to read emails contained in mailboxes 28 and 29. Finally a remote user, not shown, makes use of the system by means of an email enabled device 30, such as a cell phone or the like.

Server network 12 consists of one or more servers coupled together. A very simple server network may consist of a single server upon which both the target applications and the control application are resident; however, it is anticipated that in a majority of cases the server network will consist of several individual servers linked together to form a network. Mail server 26 will generally be resident on another computer, as will mail boxes 28 and 29.

Control application 22 is configured to control target applications 14, 16 and 18 by sending text instructions to those applications. Target applications 14, 16 and 18 could be any type of applications running on a server, such as a database application or the like. Control application 22 is a custom application which is configured to submit commands on the server network and perform tasks as ordered by one or more text commands or scripts. Command application may be written is the C language. As discussed later in this application, the command application has three major components, an execm component which launches a Queue Management Agent (QMA) for each defined Queue. The QMA component (eagent) which actually implements all the logic described in the attached status diagrams. Finally, the third component of the command application is the email parser and Headers Signature creator called by eagent. In addition, the command application has library code that implements various utility functions such as which encryption/decryption methods are to be used, a Random Access Code generation function and a Reply Rule evaluation function.

Command application 22 is configured to read emails contained in mailboxes 28 and 29 and to extract text commands from those emails. Command application 22 is further configured to read file 32 which contains a series of instructions on how text commands for each target application shall be dealt with. File 32 preferably consists of a database, but may be an XML file which contains a separate set of parameters and instructions for each target application. The behavior of the control application, and in turn the behavior of target applications 14, 16 and 18 is controlled by instruction sets 34, 36 and 38, respectively. These instruction sets, referred to as execution queues, control how text commands are dealt with.

The Control application 22 is a part of Protocol. The purpose of Control Application is to launch the separate independent Process for each defined execution queue (Queue Management Agent). The execution queue is a “scope of work”.

This scope of work has 6 major definitions:

1. The path from Remote User (RU) down to local mailbox: Remote Users (RU)>Mail Server Mailbox (MSM)>Local User /Application on the target machine (LU)

2. The Mail Server name and Mail Server Mailbox name to where the RU sends his messages.

3. The commands processing parameters.

4. Date/Time restrictions.

5. Remote Users allowed to execute commands in the Queue.

6. Security Policy applied to the Queue. Security Policy is a scope of Access Control definitions containing such parameters as Access Code length, Access Code Confirmation rules and implementation specific rules. Each Security Policy scope is identified by Security Policy ID which can be referenced from Execution Queue scope

When the Protocol control program starts, it launches Queue Manager Agent (QMA) for each defined Queue. The QMA manages the Queue activity according to protocol flow based on Protocol Status for each defined RU (see status diagram FIG. 2).

The use of control file 32 provides flexibility to the system, allowing a user to control the behavior of control application 22 simply by manipulating the contents of file 32. This allows for the possibility of adding or deleting target applications or changing how the target applications behave when text commands are received.

The system of the present invention allows a remote user to control the behavior of target applications by the use of simple text emails. The remote user will be provided with a mobile email enabled device, such as smart phone 30. The user sends an email 40 which contains a text command. The email is sent through internet 42 to mail server 26 which then places the email in an mailbox (either 28 or 29 depending on the user and the email address the user sends the email to). Control application 22 then reads the contents of email box 29 (or 28 as the case may be) and extracts the email 40. As shall be described below, control application 22 then extracts a text command 44 from the email and sends the text command to the target application pursuant to the rules laid out in queues 34, 36 or 38. Hence, the remote user can control target application simply by sending text emails. Which target applications controlled, and which text commands can be executed is a function of the remote user's access clearing, the location of the mailbox the email text command is sent to (i.e. the email address the email is sent to) and the content of the queue governing the behavior of the control application with respect to the target application. Of course, additional features of the system are required in order to ensure security and efficient operation, including authentication and parsing of messages to retrieve the text commands.

We shall now discuss how security is maintained in the system and how text commands are implemented via email. In this discussion, the following terms are given the following definitions:

Command—Any valid Server Side command or script to be executed.

User—The remote user sending the Command using email message (possible from mobile device).

Local User—The Local User/Application on the Server Site executing the Command

Local Mailbox—Local Mailbox file on the Server Side which keeps incoming mails for Local User.

Mail Server—Mail Server accepting mail messages from User.

Server Mailbox—Mail Server mailbox (target user) accepting messages sent by User.

The method/protocol is based on the following configurable parameters:

1. Command Rules.

2. Authentication Rules

3. Command restrictions

4. Intelligent Message Headers validation

Command Rules:

Where to find a command: A text command can be in Mail Subject or in Mail Body or in BOTH fields. How to find a command: The user must supply specially generated Access Code as a command prefix. The Access Code is generated by method and sent to user by email (see Access Code Generation Rules). The method will recognize the command only if Access Code has been found in a proper field (see 1).

Authentication Rules

The Access Code is generated when the Remote User requests Start of Dialog by startq command. The Method allows to request a User Confirmation for Access Code Acceptance.

The Confirmation Rules:

The purpose of Access Code Confirmation is to ensure that the Person sending the

Access Code followed by Command has the same Identity as a Remote User sending the command. The Access Code Confirmation is based on the Rule that the User must apply on the Access Code he receives from Method. For example, the rule can tell “Add 1 to first symbol of Access Code, subtract 1 from second symbol of Access Code etc”. The Rules are recorded in a special file and have simple format of rule name followed by “=” sign and rule itself. For example:

r1=“1+1,2−1,3+1,4−1”—tells to add 1 to first symbol, subtract 1 from second symbol etc.

r2=“4,3,2,1”—tells to put the Confirmation string as a reverse order of Access Code

### EXAMPLE

The confirmation string for string az1b using rule “r1” will be by2a. The confirmation string for string az1b using rule “r2” will be b1za.

The User receives the set of Confirmation Rules verbally OR as a strong confidential message (like security code for the Bank Card). If the Access Code Confirmation message fits the Confirmation Rule assigned to User, then the sender of the command is identical to the User and the Dialog can be started between the Remote User and the Protocol. Upon Dialog Termination/Renewal (see Status Diagrams) the User receives new Access Code to start the Dialog.

Command restrictions:
1. Disabled commands (OS shell implementation specific) Disabled Commands List specify which commands will be disabled for given Execution Queue, even if the command is valid in terms of other rules (for example, shutdown or reboot.
2. Time restrictions

The commands execution may be restricted to specific weekdays (such as ‘sat’ to ‘sun’) and/or during specified hours (such as ‘17:00’ to ‘07:00’). This feature allows commands execution only during “support window” out of the regular working hours.

Message Headers Validation.

For each Remote User eligible to execute command, the email headers are extracted from the first valid email. If Access Code Confirmation (ACC) is enabled, then the email headers are extracted after first confirmation message. The chain (sequence) of email message headers is saved as a Headers Signature (HS) which is became base for

Header Validation for the following email messages.

The Validation Process checks the email Message Headers for matching following rules:

1. Matching “from” and “by” dns names in “Received:” tags AND detects invalid dns entries (such as localhost).

2. If BATV (Bounce Address Tag Validation) protocol is implemented, then the “From ” initial field is compared to envelope-from part of the header message.

3. If the HS file exists, the headers sequence of incoming mail is compared to HS file. The mismatched email message is ignored

Referring now to FIG. 2, how the system cycles through various phases from idle to execution of commands shall now be discussed. In the status diagram (FIG. 2) the following states are available:

I—Initinal

W—Waiting for AC request

P—Confirmation Pending (waiting for ACC)

R—Ready to Process (waiting for mails)

C—Closed for processing

Protocol Flow Description:

Queue Definition (Queue):

One or more Remote Users (RU)→Mail Server Mailbox (MSM)→Local User/Application on the target machine (LU)

I status (INITIAL):

This is intermediate status when the new Queue Manager Agent is started

I status operations:

Set up default values and RU related Status Files, then change status to W for ALL RU defined for the Queue.

For each RU having W status (Waiting for AC (Access Code) request) (FIG. 3):

The new mail coming from MSM to LU is examined for AC request (Subject:startq command)

If the startq has been sent by RU, the new AC generated and sent to RU. If the ACC (Access Code Confirmation) is required for RU, its status is changed to P (ACC Pending), otherwise his status is changed to R (Ready to Process).

For each RU having P status (ACC Pending) (FIG. 4):

The new mail coming from MSM to LU is examined for ACC based on Reply Rule. If the ACC is valid, the status is changed to R (Ready to Process), else the Status is changed to C (Closed) and RU became disabled (can be re-enabled by Server Side). Alternatively, the implementation can force status change from P to W for the wrong ACC. If the ACC is not accepted after predefined TimeOut, the Status is changed to W (Waiting for AC request).

For each RU having R status (Ready to Process) (FIG. 5):

Wait for New message. If the message contains correct AC as expected (Subject or Body), the command is processed and the result is sent back to RU. Then the Command execution timestamp is recorded. If the message does not contain a command (no valid AC found) the message is ignored. If any command was not received by QMA after predefined Time Out, the status is changed to W. If the command is “stopq”, the status is changed to W.

### Example

The invention will now be further explained using an example of how the invention may be implemented for use with email banking. Today, the major banks allow email money transfer. The process involves active participation of two players: The sender of the money and the receiver. Both of them (Sender and Receiver) are required to use online banking interface to initiate and to complete the transaction.

The following is a small design of the email banking implementation based on the Protocol of the present invention which significantly simplifies the business process flow and add more options, while the Security needed for such operations is preserved on a highest level:

The client having banking account will have set of allowed operations such as:
Show Account Balance and recent transactions.
Transfer money from account to account (among his personal/business accounts).
Pay bills (based on predefined list of bills)
Transfer money to other clients of the current bank (based on predefined account numbers).
Transfer money to other clients of other banks.

The message in this case should have more “strict” format and be unique for each transaction type.

For example, the message of Transfer money from account to account can look as follow:

Subject:$AccessCode:transfer XXXXUSDICAD from AccountNumber to

AccountNumber

And the message of Transfer money to other client of other bank can have more complex format:

Subject:$AccessCode:transfer XXXXUSDICAD from AccountNumber to BankCode/Clientld/AccountNum

Architecture:

In this case, the local mailbox defines the target application performing email transactions.

RU defines the subscribed client sending the transaction.

The Execution Queue is defined as follow:

RU→EmailServerMailbox→Local Mailbox (Email Banking Application)

Using this approach, the single queue can manage thousands of descriptors (Remote

Users) concurrently.

Data Store and Subscriptions Management.

While the Protocol Flow is never changed (see status diagrams), the implementation of Commands Processing (see Commands Processing on page 7) can vary from implementation to implementation based on business and target application architecture. In this scenario, the command interpreter is not Operating System shell, but Banking Application that must be called in some way by QMA (either by invoking program or calling web service or writing the command with all supplied parameters to some application queue etc).

The function of command validation and access restrictions can be implemented as a pluggable modules and dynamically invoked by the Protocol without affecting the Protocol Stream Flow.

The Data Store of the Protocol implementation for email banking can be based on RDBMS. The Execution Queues definitions and run time control, Security Policy management, Users management, Reply Rules management and Users subscription can be implemented as a GUI front end (Java).

The very simplified schema for subscription control is listed below:

create table registered_users (client_id number not null, client_email varchar2(80) not null);

create table registered_actions (client_id number not null, action_id number not null—refer to scope of actions such as—transfer, transactions list etc);

create table registered_accounts (clinet_id number not null, account_id varchar2(40) not null);

create table registerd_bills (client_id number not null, bill_owner_id number not null—Identifies the registered bill id)

### Implementation Example

The Client named Bob Fisher having email bob fisher@magma.ca is a registered user. Upon the registration, the client receives personal set of Reply Rules which has to be kept in a safe, secured place. To use the email banking he needs to send messages to ebank@royalbank.com. When the first Request Dialog message arrives (Subject:startq), the unique Access Code is generated and sent back to bob fisher@magma.ca for confirmation. The client (Bob Fisher) compose reply message (based on Reply Rule) and sends it back to ebank@royalbank.com. If the Reply Message is correct, then the Headers Signature is created for bob_fisher@magma.ca and the Queue status changed to R (Ready to process) for this specific RU. When the client wants to send Money Transfer instruction (see message example above) he uses the Access Code as a command prefix in the Subject line and sends the email to ebank@royalbank.com. If the Headers Signature is equal to one used as Money Transfer instruction, then the transaction is sent to back end application, and the answer is sent back to the Client. The client can repeat and send as many transactions as he wants. The Dialog stops when the client sends stopq command or when no new transactions are accepted during timeout (session inactivity) period. Then the Protocol Status is changed back to W and the communication with client is terminating (until next “startq” command).

The invention shall now be further explained using an example of how the invention is used to allow two Ales based applications to communicate with each other using xml messages in the body of emails.

### B2B Example

Process A initiates communication with process B by sending startq command via email to process B. Process B reads the request and sends the AC back to process A (the status is changed to R and a Headers Signature is created). Process A receives the AC and composes an XML message as follows:

Subject:AC:[optional header message]

Body:[<xml request>]

The request is sent to Process B via server email. Process B processes the request and sends the results to Process A as an XML message. Process A receives the results and performs actions based on the results received. Process A then sends a termination request to process B (stopq) and process B receives the stopq request and the status is changed to W.

The communication between two Ales process can be secured using Ales Reply Rules as follows:
1. The same Rules Container File is created in configuration directory for both processes.
2. Process A sends startq request to process B.
3. Process B sends a reply rule number to process A.
4. Process A encrypts the XML message using string derived from the Access Code by applying proper Reply Rule send by process B.
5. Process A sends encrypted XML message to process B.
6. Process B decrypts the message using the same key (Reply Rule) it sent to process A.
7. Process B encrypts the response message and sends it to process A.
8. The dialog continues the same way until process A sends stopq request to process B.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A Protocol for remotely and securely controlling a target application on a server comprising the steps of:
a. Providing a mail server coupled to the server, the mail server configured to send and receive emails to and from a remote user, the mail server having a unique mailbox for storing emails received from the remote user;
b. Providing a control application configured to control the target application by means of a plurality of text commands, the control application configured to read emails in the unique mailbox, the control application being further configured to identify a text command in an email, the control application being configured to read a reference file containing a set of instructions on how the control application shall treat text commands, the control application being further configured to execute the text command pursuant to the set of instructions;
c. The remote user sending a command email to the unique mailbox, the command email containing a text command;
d. The control application reading the command email and executing the text command contained in the command email.

2. The method of remotely controlling a target application as defined in claim 1 wherein the control application is configured to generate a unique access code in reply to a request email from the remote user, the control application being further configured to cause the mail server to send the unique access code to the remote user via a first code containing email, the control application configured to ignore any command emails from the remote user until the control application identifies a confirmation code in a subsequent email from the remote user.

3. The method of remotely controlling a target application as defined in claim 1 wherein the control application is configured to recognize the text command contained in the command email by identifying a unique identifier code contained in the email and then selecting a sequence of text located adjacent the unique identifier code, the text command being located in the sequence of text adjacent the unique identifier code.

4. The method of remotely controlling a target application as defined in claim 3 wherein the control application is configured to generate a unique access code in reply to a request email from the remote user, the control application being further configured to cause the mail server to send the unique access code to the remote user via a first code containing email, the unique identifier code being derived from the unique access code.

5. The method of remotely controlling a target application as defined in claim 1 wherein the control application is coupled to a list of authorized users, the control application configured to execute the text command contained in the command email only if the remote user sending the command email is listed in the list of authorized users.

6. The method of remotely controlling a target application as defined in claim 4 wherein the control application is configured to create a time interval upon sending the unique access code, the control application being further configured not to execute text commands received from the remote user after the expiration of the time interval.

7. The method of remotely controlling a target application as defined in claim 2 wherein the unique Confirmation code is derived from the unique access code by the remote user applying a reply rule algorithm to the unique access code.

8. The method of remotely controlling a target application as defined in claim 4 wherein the request email and the command email both have a header portion identifying a path through which the request email and the command emails were transmitted to the unique mailbox, the control application being configured to verify that the path of the command email is identical to the path of the request email before executing the text command contained in the command email.

9. The method of remotely controlling a target application as defined in claim 3 wherein the unique identifier code is a positioned immediately before the text command.

10. A system for remotely and securely controlling a plurality of target applications on a server network, the system comprising:
a. a mail server coupled to the server, the mail server configured to send and receive emails to and from a plurality of remote users, the mail server having a unique mailbox for storing emails received from each of the remote users;
b. a control application configured to control each target application by means of a plurality of text commands, the control application configured to read emails in the unique mailboxes, the control application being further configured to identify a text command in an email;
c. the control application being configured to read a reference file, the reference file containing a set of instructions for each target application on how the control application shall treat text commands for that target application, the control application being further configured to execute the text commands pursuant to the sets of instructions.

11. The system for remotely controlling a plurality of target applications on a server network as defined in claim 10 wherein the control application is configured to generate a unique access code in reply to a request email from the remote users, the control application being further configured to cause the mail server to send the unique access codes to the remote users via a first code containing email, the control application configured to ignore any command emails from the remote users unless the remote user sends a confirmation email to the unique mailbox confirming receipt of the access code.

12. The system for remotely controlling a plurality of target applications on a server network as defined in claim 10 wherein the control application is configured to recognize the text command contained in the command email by identifying a unique identifier code contained in the command email and then selecting a sequence of text located adjacent the unique identifier code, the text command being located in the sequence of text adjacent the unique identifier code.

13. The system for remotely controlling a plurality of target applications on a target network as defined in claim 10 wherein the reference file is configured to be periodically modified to change the control applications treatment of the target applications.

14. The system for remotely controlling a plurality of target applications on a target network as defined in claim 13 wherein the reference file comprises an XML file.

15. The system for remotely controlling a plurality of target applications on a target network as defined in claim 13 wherein the reference file comprises a database file.
